(19) United States
(12) Patent Application Publication
(10) Pub. No.: US 2013/0245984 A1
(43) Pub. Date: Sep. 19, 2013

(54) APPARATUSES AND METHODS FOR MAGNETOMETER ALIGNMENT CALIBRATION WITHOUT PRIOR KNOWLEDGE OF THE LOCAL MAGNETIC FIELD

(71) Applicant: Hua Sheng, Clarksburg, MD (US)

(72) Inventor: Hua Sheng, Clarksburg, MD (US)

(73) Assignee: Hillcrest Laboratories, Inc., Rockville, MD (US)

(21) Appl. No.: 13/885,246

(22) PCT Filed: Nov. 17, 2011
(86) PCT No.: PCT/US2011/061163

§ 371 Date: May 14, 2013

Related U.S. Application Data
(60) Provisional application No. 61/414,560, filed on Nov. 17, 2010.

(51) Int. Cl. G01C 25/00; G01D 18/00

(52) U.S. Cl. CPC G01C 25/00; G01D 18/002
USPC 702/94

(57) ABSTRACT

Apparatuses and methods calibrate attitude dependent magnetometer alignment parameters of a magnetometer mounted together with other angular position sensors on a device without prior knowledge of the local magnetic field and allowing a constant but unknown offset of the yaw angle in the reference attitudes with respect to an earth-fixed coordinate system. The method includes acquiring magnetic field measurements from the magnetometer and corresponding estimated angular positions subject to an unknown yaw offset relative to a gravitational reference system. The method further includes iteratively computing a scale and vector components of a quaternion representing a misalignment matrix, an inclination angle of local magnetic field, and a yaw angle offset, using an extended Kalman filter (EKF) infrastructure with a specific designed model and constraints, based on the magnetic field measurements and the corresponding estimated angular positions.

### RELATED APPLICATION

This application is related to, and claims priority from, U.S. Provisional Patent Application Ser. No. 61/414,560, entitled “Magnetometer Alignment Calibration Without Prior Knowledge of Inclination Angle and Initial Yaw Angle”, filed on Nov. 17, 2010, the disclosure of which is incorporated here by reference.

### TECHNICAL FIELD

The present inventions generally relate to apparatuses and methods for calibrating attitude dependent magnetometer alignment parameters of a magnetometer mounted together with other angular position sensors on a device.

### BACKGROUND

The increasingly popular and widespread mobile devices frequently include so-called nine-axis sensors which consist of a 3-axis (3-D) gyroscope, a 3-axis (3-D) accelerometer and a 3-axis (3-D) magnetometer. The 3-D gyroscope measures angular velocities. The 3-D accelerometer measures linear acceleration. The 3-D magnetometer measures a local magnetic field vector (or a deviation thereof). In spite of their popularity, the foreseeable capabilities of these nine-axis sensors are not fully exploited due to the difficulty of calibrating and removing undesirable effects from the magnetometer measurements on one hand, and the practical impossibility to make a reliable estimate of the yaw angle using only the gyroscopes and the accelerometer.

A rigid body's (i.e., by rigid body designating any device to which the magnetometer and motion sensors are attached) 3-D angular position with respect to an Earth-fixed gravitational orthogonal reference system is uniquely defined. When a magnetometer and an accelerometer are used, it is convenient to define the gravitational reference system as having the positive Z-axis along gravity, the positive X-axis pointing to magnetic North and the positive Y-axis pointing East. The accelerometer senses gravity, while from magnetometer's measurement it can be inferred from the Earth's magnetic field that points North (although it is known that the angle between the Earth's magnetic field and gravity is may be different from) 90°. This manner of defining the axis of a gravitational reference system is not intended to be limiting. Other definitions of an orthogonal right-hand reference system may be derived based on the two known directions, gravity and the magnetic North.

Motion sensors attached to the 3-D body measure its position (or change thereof) in a body orthogonal reference system defined relative to the 3-D body. For example, as illustrated in FIG. 1 for an aircraft, without loss of generality, the body reference system has the positive X-axis pointing forward along the aircraft's longitudinal axis, the positive Y-axis is directed along the right wing and the positive Z-axis is determined considering a right-hand orthogonal reference system (right hand rule). If the aircraft flies horizontally, the positive Z-axis aligns to the gravitational system's Z-axis, along the gravity. While the roll and pitch in the gravitational reference system can be determined using a 3-D accelerometer alone or with a 2 or 3-D rotational sensors together attached to the body and based on the gravity's known direction (see, e.g., Liberty patents—U.S. Pat. Nos. 7,158,118, 7,262,760 and 7,414,611), the absolute yaw angle in the gravitational reference system is more difficult to estimate accurately, making it preferable to augment those readings with the Earth's magnetic field (or more precisely its orientation) from magnetometer measurements.

Based on Euler's theorem, the body reference system and the gravitational reference system (as two orthogonal right-hand coordinate systems) can be related by a sequence of rotations (no more than three) about coordinate axes, where successive rotations are about different axis. A sequence of such rotations is known as an Euler angle-axis sequence. Such a reference rotation sequence is illustrated in FIG. 2. The angles of these rotations are angular positions of the device in the gravitational reference system.

A 3-D magnetometer measures a 3-D magnetic field representing an overlap of a 3-D static magnetic field (e.g., Earth's magnetic field), hard- and soft-iron effects, and a 3-D dynamic near field due to external time dependent electro-magnetic fields. The measured magnetic field depends on the actual orientation of the magnetometer. If the hard-iron effects, soft-iron effects and dynamic near fields were zero, the locus of the measured magnetic field (as the magnetometer is oriented in different directions) would be a sphere of radius equal to the magnitude of the Earth's magnetic field. The non-zero hard- and soft-iron effects render the locus of the measured magnetic field to be an ellipsoid offset from origin.

Hard-iron effect is produced by materials that exhibit a constant magnetic field with respect to the magnetometer's body frame, thereby generating constant offsets of the components of the measured magnetic field. As long as the orientation and position of the sources of magnetic field resulting in the hard-iron effects relative to the magnetometer is not changing, the corresponding offsets are also constant.

Unlike the hard-iron effect that yields a constant magnetic field with respect to the magnetometer's body frame, the soft-iron effect is the result of material that influences, or distorts, a magnetic field (such as, iron and nickel), but does not necessarily generate a magnetic field itself. Therefore, the soft-iron effect is a distortion of the measured field depending upon the location and characteristics of the material causing the effect relative to the magnetometer and to the Earth's magnetic field. Thus, soft-iron effects cannot be compensated with simple offsets, requiring a more complicated procedure.

The calibration parameters of a three-axis magnetometer can be categorized into two types: (1) attitude-independent parameters, such as, scale, skew, and offset, which parameters can be determined based on magnetometer's measurements without knowledge of attitude(s) of magnetometer with respect to earth-fixed coordinate system, and (2) attitude-dependent parameters, such as, misalignment between magnetometer body coordinate system and device body reference system, which parameters can only be determined based on magnetometer's measurements in conjunction with corresponding device's angular positions with respect to earth-fixed coordinate system. The misalignment is due to imperfect installation of the magnetometer relative to the device (i.e., misalignment relative to the device's body reference system), and/or the soft-iron effects.

Some known conventional methods (e.g., described in J. E. Sedlak, Iterative Magnetometer Calibration, AIAA/AAS Astrodynamics Specialist Conference, Keystone, Colo., August. 2006, and J. A. Hashmall and J. E. Sedlak, New Attitude Sensor Alignment Calibration Algorithms, 53^{rd} Int. Astronautical Congress, IAF, Houston, Tex., October 2002) solve the magnetometer alignment (totally 3 independent variables) using a quaternion estimation algorithm (see, e.g., M. D. Shuster and S. D. Oh, Three-Axis Attitude Determination from Vector Observations, J. Guidance and Control, Vol. 4, No. 1, January-February 1981, pp. 70-77) when local magnetic field in the earth-fixed coordinate system is known and no initial yaw angle offset in the referenced attitudes.

Another conventional method (described in P. Guo. et al., The Soft Iron and Hard Iron Calibration Method using Extended Kalman Filter for Attitude and Heading Reference System, Position, Location and Navigation Symposium IEEE/ION, pg 1167-1174, May 5-8, 2008) solves all the magnetometer parameters together along with inclination angle and initial yaw angle offset, totally 14 independent variables which significantly increases the system's complexity and instability. In addition, it requires the knowledge of the horizontal component of local magnetic field in the earth-fixed coordinate system. More importantly, it neither addresses how to work robustly with any kinds of sequences of data, nor provides a method to verify if the algorithm is really converged although the filter may has converged given filter runs in a more general unknown environment.

Therefore, it would be desirable to provide devices, systems and methods that enable real-time reliable use of magnetometer measurements and angular position estimates from other motion sensors attached to a device for determining alignment of the magnetometer rapidly and robustly.

### SUMMARY

Apparatuses and methods calibrate attitude dependent magnetometer alignment parameters of a magnetometer mounted together with other angular position sensors on a device without prior knowledge of the magnetic field and allowing a constant but unknown offset of yaw angles in the reference attitudes with respect to an earth-fixed coordinate system. The calibration converges fast while still stable enough.

According to one exemplary embodiment, a method for calibrating attitude dependent magnetometer alignment parameters of a magnetometer mounted together with other angular position sensors on a device is provided. The method includes acquiring magnetic field measurements from the magnetometer and corresponding estimated angular positions subject to an unknown yaw offset of the device relative to a gravitational reference system. The method further includes iteratively computing a scale and vector components of a quaternion representing a misalignment matrix, an inclination angle of local magnetic field, and an initial yaw angle offset using an extended Kalman filter (EKF) infrastructure with specific designed model and constraints based on the magnetic field measurements and the corresponding estimated angular positions.

According to another exemplary embodiment, an apparatus configured to perform a calibration of attitude-dependent magnetometer alignment parameters of a magnetometer mounted together with other angular position sensors on a device is provided. The apparatus includes configured to receive magnetic field measurements and corresponding estimated angular positions subject to an unknown yaw offset of the device relative to a gravitational reference system. The apparatus further includes data processing unit configured to iteratively compute a scale and vector components of a quaternion representing a misalignment matrix, an inclination angle of local magnetic field, and an initial yaw angle offset using an extended Kalman filter (EKF) infrastructure with a specific designed model and constraints, based on the magnetic field measurements and the corresponding estimated angular positions.

According to another exemplary embodiment, a computer readable medium storing executable codes which when executed by a processor make the processor execute a method calibrating attitude dependent magnetometer alignment parameters of a magnetometer mounted together with other angular position sensors on a device is provided. The method includes acquiring magnetic field measurements from the magnetometer and corresponding estimated angular positions subject to an unknown yaw offset of the device relative to a gravitational reference system. The method further includes iteratively computing a scale and vector components of a quaternion representing a misalignment matrix, an inclination angle of local magnetic field, and an initial yaw angle offset using an extended Kalman filter (EKF) infrastructure with specific designed model and constraints based on the magnetic field measurements and the corresponding estimated angular positions.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is an illustration of a 3-D body reference system;

FIG. 2 is an illustration of a transition from a gravitational reference system to a body reference system;

FIG. 3 is a block diagram of a sensing unit, according to an exemplary embodiment;

FIG. 4 is a block diagram of a method for aligning a 3-D magnetometer to a device body reference coordinate system, according to an exemplary embodiment;

FIG. 5 is a block diagram of a method for aligning a 3-D magnetometer in a nine-axis system, according to an exemplary embodiment;

FIG. 6 is a flow diagram of a method for calibrating attitude dependent magnetometer alignment parameters of a magnetometer mounted together with other angular position sensors on a device, according to an exemplary embodiment.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a sensing unit including motion sensors and a magnetometer attached to a rigid 3-D body (“the device”). However, the embodiments to be discussed next are not limited to these systems but may be used in other systems including a magnetometer or other sensor with similar properties.

Reference throughout the specification to “one embodiment” or “an embodiment” means that a particular feature, structure, or characteristic described in connection with an embodiment is included in at least one embodiment of the present invention. Thus, the appearance of the phrases “in one embodiment” or “in an embodiment” in various places throughout the specification is not necessarily all referring to the same embodiment. Further, the particular features, structures or characteristics may be combined in any suitable manner in one or more embodiments.

According to an exemplary embodiment illustrated in FIG. 3, a sensing unit 100 that may be attached to a device in order to monitor the device's orientation includes motion sensors 110 and a magnetometer 120 attached to the device's rigid body 101. Concurrent measurements performed by the motion sensors 110 and the magnetometer 120 yield signals sent to a data processing unit 130 via an interface 140.

The interface 140 and the data processing unit 130 constitute a magnetometer calibration unit 150. In FIG. 3, the magnetometer calibration unit 150 is located on the rigid body 101. However, in an alternative embodiment, the magnetometer calibration unit may be remote, receiving data from the magnetometer and the motion sensors or retrieving the data from a data storage medium. The data processing unit 130 includes at least one processor to perform calculations.

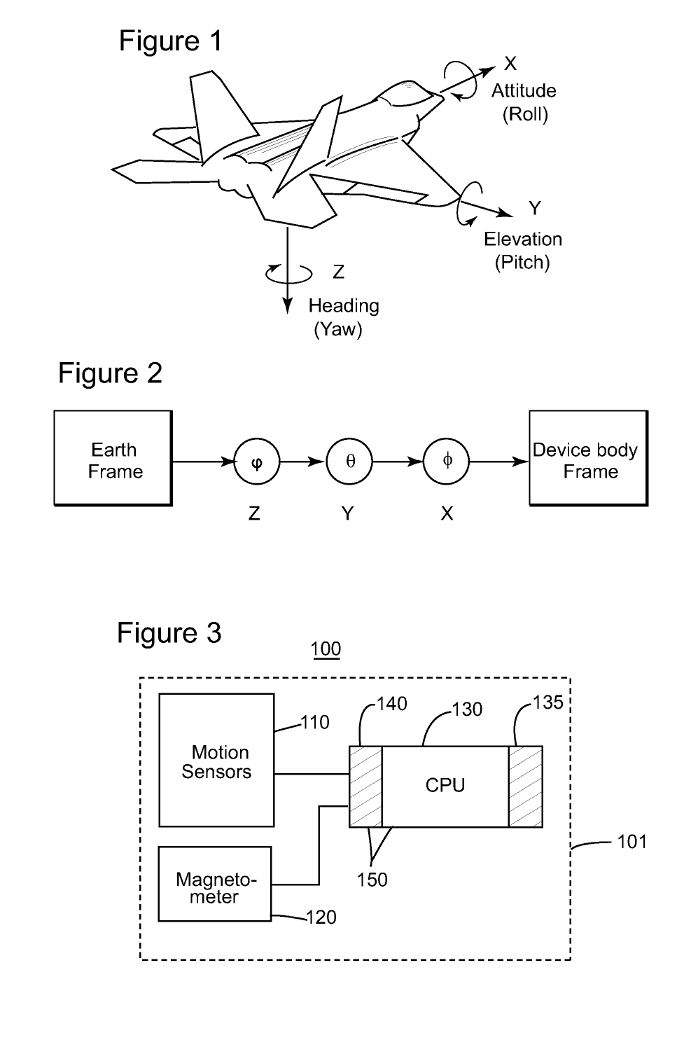

A body coordinate system may be defined relative to the device's body 101 (see, e.g., FIG. 1). The motion sensors 110 and the magnetometer 120 being fixedly attached to the rigid body 101, they generate signals related to observable (e.g., magnetic field, angular speed or linear acceleration) in the body reference system. However, in order, for example, to determine body's orientation in a reference system independent from the device one has to be able to relate these measured quantities to an observer reference system. One may consider the observer's reference system to be an inertial reference frame, and the body reference system to be a non-inertial reference system. For an observer located on Earth, gravity provides one reference direction and magnetic North provides another. The observer's reference system may be defined relative to these directions. For example, a gravitational reference system may be defined to have z-axis along gravity, y-axis in a plane including gravity and the magnetic North direction, and, using the right hand rule, x-axis pointing towards East. However, this particular definition is not intended to be limiting. In the following description, the term “gravitational reference system” is used to describe a reference system defined using gravity and magnetic North.

The signals reflect quantities measured in the body reference system. These measurements in the body reference system are further processed by the data processing unit 130 to be converted into quantities corresponding to a gravitational reference system. For example, using rotation sensors and a 3-D accelerometer, a roll and pitch of the body reference system to a gravitational orthogonal reference system may be inferred. In order to accurately estimate a yaw angle of the device in the gravitational orthogonal reference system, determining the orientation of the Earth's magnetic field from the magnetic field measured in the body's reference system is necessary.

For determining the orientation of the Earth's magnetic field from the magnetic field measured in the body reference system, the data processing unit 130 corrects the misalignment of measured 3-D magnetic field (which has been calculated from magnetometer signals using attitude independent calibration parameters) using a scale and a misalignment matrix. The misalignment is due to soft-iron effects, and/or mechanic misalignment and/or manufacture intrinsic misalignment. Once the data processing unit 130 completes all these corrections, the resulting magnetic field may reasonable be assumed to be a local magnetic field corresponding to the Earth's magnetic field. The Earth's magnetic field naturally points North, slightly above or below a plane perpendicular to gravity, by a known angle called “dip angle” or “inclination angle”.

The data processing 130 may be connected to a computer readable medium 135 storing executable codes which, when executed, make the system 100 to perform methods for determining (calibrating or aligning) attitude-dependent magnetometer-alignment parameters including the equivalent effect resulting from surrounding soft-iron.

Methods for computing the misalignment of a 3-D magnetometer with respect to an Earth-fixed gravitational reference system without prior knowledge about the magnetic field especially the dip angle (i.e., inclination which is departure from a plane perpendicular to gravity of the local Earth magnetic field) and allowing an unknown constant initial yaw angle offset in the sequences of concurrently measured angular positions with respect to the device's body reference system are provided. The equivalent misalignment effect resulting from the soft-iron effects is also addressed in the same manner. A verification method for alignment accuracy is augmented to control the alignment algorithm dynamics. Combining the calibration and the verification makes the algorithm to converge faster, while remaining stable enough. It also enables real-time implementation to be reliable, robust, and straight-forward.

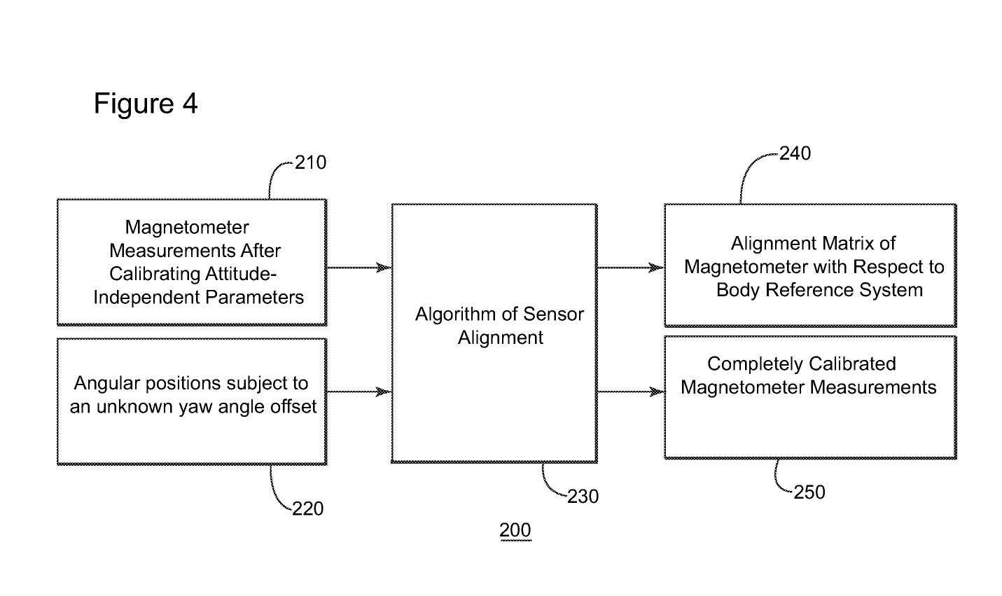

FIG. 4 is a block diagram of a method 200 for compute the misalignment of a 3-D magnetometer with respect to the device's body reference system (that is, to calibrate the attitude-dependent parameters) according to an exemplary embodiment. The method 200 has as inputs the magnetic field 210 measured using the magnetometer and calculated using calibrated attitude independent parameters (scale, offset, and cross-coupling/skew), and angular positions 220 subject to an unknown yaw offset. Using these inputs, an algorithm for sensor alignment 230 outputs an alignment matrix 240 of the 3-D magnetometer relative to the device's body reference system, the use of which enables calculating a completely calibrated value 250 of the measured magnetic field.

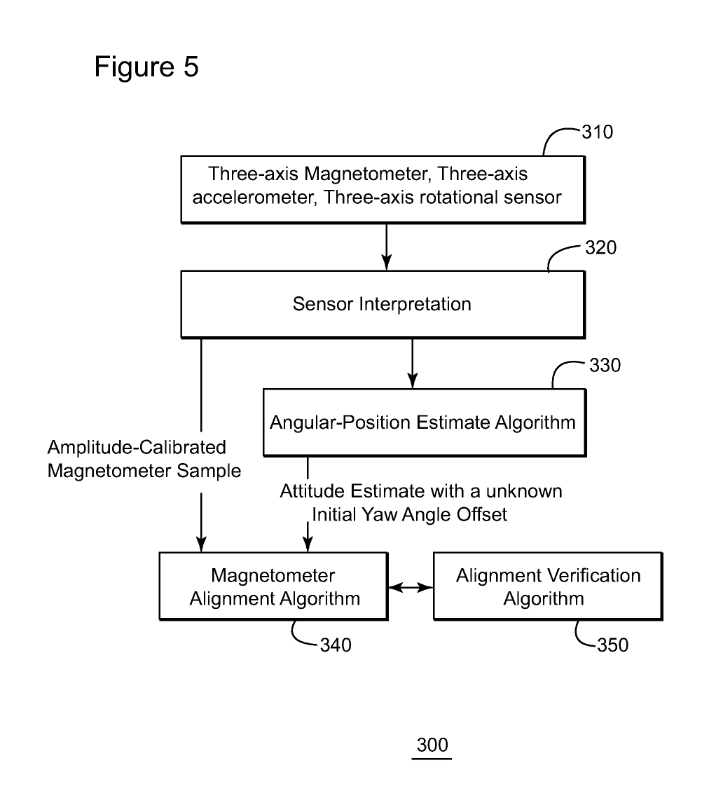

FIG. 5 is another block diagram of a method 300 for aligning a 3-D magnetometer in a nine-axis system, according to another exemplary embodiment. The block diagram of FIG. 3 emphasizes the data flow. A system 310 includes a 3-D magnetometer, a 3-D accelerometer and a 3-D rotational sensor whose sensing signals are sent to a sensor interpretation block 320. The sensors provide noisy and distorted sensing signals that correspond to the magnetic field, the linear acceleration, and the angular rates for the device. The sensor interpretation block 320 uses pre-calculated parameters (such as, the attitude-independent parameters) to convert the sensing signals into standardized units and (1) to remove scale, skew, and offset from the magnetometer measurement but not enough to correcting for alignment, (2) to remove scale, skew, offset, and nonlinearity for the accelerometer, (3) to remove scale, skew, offset, and linear acceleration effect for the rotational sensor, and (4) to align the accelerometer and rotational sensor to the body reference system. Those interpreted signals of the accelerometer and the rotational sensor are then used by an angular position estimate algorithm 330 to generate an estimate of the device's attitude (i.e., angular positions with respect to the Earth-fixed gravitational reference system) except for an unknown yaw angle offset. The estimated attitudes in a time sequence and the attitude-independent calibrated values of the magnetic field are input to the algorithm 340 for magnetometer alignment estimate. Then the estimated yaw angle offset and inclination angle along with magnetometer samples are then input to the alignment verification algorithm 350 for evaluating the accuracy of the estimated alignment matrix. The alignment verification algorithm 350 provides a reliable indication as to whether the alignment estimation algorithm 340 has performed well enough.

The following Table 1 is a list of notations used to explain the algorithms related to the method for calibrating the attitude dependent parameters.

TABLE 1

| Notation | Unit | Description |
|---|---|---|
| ₙ | | At time step tₙ |
| ᵢ | | Time step index |
| _{n+1\|n+1} | | The update value at time step tₙ₊₁ after |
| | | measurement at time step tₙ₊₁ |
| _{n+1\|n} | | The predicted value at time step tₙ₊₁ given |
| | | the state at time step tₙ before measurement |
| | | at time step tₙ₊₁ |
| ^{E} | | Earth-fixed gravitational reference system |
| ^{D} | | The device's body reference system |
| ^{M} | | Magnetometer-sensed reference system |
| × | | Matrix multiplication |
| • | | Dot product of two vectors |
| · | | Element-wise multiplication |
| ^{E}H | Gauss | Actual Earth magnetic field vector in the |
| | | Earth-fixed gravitational reference system |
| ^{M}Bₙ | Gauss | The measurement vector of the magnetic |
| | | field by the magnetometer including |
| | | magnetic induction in magnetometer- |
| | | sensed-reference system |
| _{E}^{M}Rₙ | | The rotation matrix brings Earth-fixed |
| | | gravitational reference system to |
| | | magnetometer-sensed reference system at |
| | | time step tₙ |
| _{D}^{M}R | | misalignment between magnetometer's |
| | | measurement and device body reference |
| | | system |
| _{E}^{D}Rₙ | | true angular position of device's body |
| | | reference system with respect to the Earth- |
| | | fixed reference system at time step tₙ |
| θ | Radian | Inclination (dip) angle of local geomagnetic |
| | | field relative to a plane perpendicular to |
| | | gravity |
| φ₀ | Radian | Initial yaw angle offset in the sequence of |
| | | angular-positions |
| ^{T} | | Matrix transpose |
| ^{M}\tilde{B}ₙ | | The normalized ^{M}Bₙ |
| _{E}^{D}\hat{R}ₙ | | Estimated _{E}^{D}Rₙ using other sensors and |
| | | sensor-fusion algorithm but is subject to |
| | | initial yaw angle offset |
| A | | Same as _{D}^{M}\hat{R} for simplicity |
| C | | $Is defined as [ \begin{matrix}cos {ϕ}_{0} •cos θ \\ sin {ϕ}_{0} •cos θ \\ sin θ\end{matrix} ]$ |
| $[ \begin{matrix}{q}_{0} & {q}_{1} & {q}_{2} & {q}_{3}\end{matrix} ]$ | | The scale and vector components of a quaternion representing the rotation |
| EKF | | extended Kalman filter |
| X | | State of EKF |
| P | | Error covariance matrix of X |
| Zₙ₊₁ | | Measurement vector of the EKF at time step |
| | | tₙ₊₁ |
| h(X) | | Observation model of EKF |
| Wₙ₊₁ | | Measurement noise vector at time step tₙ₊₁ |
| $\frac{\partial A}{\partial {q}_{0}}$ | | Partial derivative of A with respect to q₀ |
| Gₙ₊₁ | | ${}_{E}^{D}{\hat{R}}{}_{n + 1}^{} \times {[ \begin{matrix}cos {ϕ}_{0} •cos θ \\ sin {ϕ}_{0} •cos θ \\ sin θ\end{matrix} ]}_{n + 1 \vert n}$ |
| Hₙ₊₁ | | the Jacobian matrix of partial derivatives of |
| | | h with respect to X at time step tₙ₊₁ |
| \tilde{H}ₙ₊₁ | | The estimate of Hₙ₊₁ |
| Qₙ | | The error covariance matrix of the process |
| | | model of EKF |
| rₙ₊₁ | | The innovation vector at time step tₙ₊₁ |
| Sₙ₊₁ | | Innovation covariance matrix |
| Rₙ | | The error covariance matrix of the |
| | | measurement model of EKF |
| σₓ² | | The normalized noise variance of x-axis of |
| | | magnetometer |
| Kₙ₊₁ | | Optimal Kalman gain |
| ₋₁ | | Matrix inverse |
| X(1:4) | | The 1^{st} to 4^{th} elements of vector X |
| \|v\| | | The magnitude of vector v |
| Const | | A predefined constant |
| Q₀ | | A baseline constant error covariance matrix |
| | | of process model |
| k₁ | | A scale factor between 0 and 1 used for |
| | | adjusting Qₙ |
| k₂ | | A scale factor between 0 and 1 used for |
| | | adjusting Qₙ |
| \tilde{G}ᵢ | | The best estimate of magnetic field |
| | | measurement in device-fixed body reference |
| | | system for time step tᵢ |
| L | | A 3x3 matrix |
| u | | A 3x3 unitary matrix |
| s | | A 3x3 diagonal matrix with nonnegative |
| | | diagonal elements in decreasing order |
| v | | A 3x3 unitary matrix |
| w | | A 3x3 diagonal matrix |
| ele1 | | A 1x3 vector variable |
| ele2 | | A 1x3 vector variable |
| ele3 | | A 1x3 vector variable |
| ele4 | | A 1x3 vector variable |
| ele5 | | A 1x3 vector variable |
| ele6 | | A 1x3 vector variable |
| ele7 | | A 1x3 vector variable |
| ele8 | | A 1x3 vector variable |
| ele9 | | A 1x3 vector variable |

The main sources of alignment errors are imperfect installation of the magnetometer relative to the device (i.e., misalignment relative to the device's body reference system), and the influence from soft-iron effects. The magnetometer measurement value after compensating/calibrating all attitude-independent parameters at time step tₙ measures

^{M}Bₙ=_{E}^{M}Rₙ×^{E}H Equation 1

where _{E}^{M}Rₙ can be decomposed into

_{E}^{M}Rₙ=_{D}^{M}R×_{E}^{D}Rₙ Equation 2

_{D}^{M}R is the misalignment matrix between magnetometer's measurement and the device body reference system, _{E}^{D}Rₙ is true angular position with respect to the Earth-fixed coordinate system at time step tₙ. The best estimate of _{E}^{D}Rₙ using three-axis accelerometer and three-axis rotational sensor is denoted as _{E}^{D}\hat{R}ₙ. This estimate has high accuracy in a short of period of time except for an initial yaw angle offset.

$${}_{E}^{D}{R}{}_{n}^{} = {}_{E}^{D}{\hat{R}}{}_{n}^{} \times [ \begin{matrix}cos {ϕ}_{0} & - sin {ϕ}_{0} & 0 \\ sin {ϕ}_{0} & cos {ϕ}_{0} & 0 \\ 0 & 0 & 1\end{matrix} ] \qquad Equation 3$$

^{E}H can be represented as

^{E}H=[cos θ0 sin θ]^{T}·|^{E}H| Equation 4

Without limitation, magnetic North is used as the positive X axis of the Earth-fixed gravitational reference system. Substituting Equations 2-4 into Equation 1, one obtains

$$\begin{matrix}{}_{}^{M}{B}{}_{n}^{} = {}_{D}^{M} R \times {}_{E}^{D}{\hat{R}}{}_{n}^{} \times [ \begin{matrix}cos {ϕ}_{0} & - sin {ϕ}_{0} & 0 \\ sin {ϕ}_{0} & cos {ϕ}_{0} & 0 \\ 0 & 0 & 1\end{matrix} ] \times [ \begin{matrix}cos θ \\ 0 \\ sin θ\end{matrix} ] \cdot \vert {}^{E} H \vert & Equation 5 \\ { }^{M} {\tilde{B}}_{i} = {}_{D}^{M} R \times {}_{E}^{D}{\hat{R}}{}_{i}^{} \times [ \begin{matrix}cos {ϕ}_{0} \cdot cos θ \\ sin {ϕ}_{0} \cdot cos θ \\ sin θ\end{matrix} ] & Equation 6\end{matrix}$$

The problem then becomes to estimate

$${}_{D}^{M} R and [ \begin{matrix}cos {ϕ}_{0} \cdot cos θ \\ sin {ϕ}_{0} \cdot cos θ \\ sin θ\end{matrix} ]$$

given the matrices of ^{M}\tilde{B}ₙ and _{E}^{D}\hat{R}ₙ. For simplicity, note _{D}^{M}\hat{R}ₙ as A and define C as

$$C • [ \begin{matrix}cos {ϕ}_{0} •cos θ \\ sin {ϕ}_{0} •cos θ \\ sin θ\end{matrix} ] \qquad Equation 7$$

An extended Kalman filter (EKF) infrastructure whose model of state is designed to consist of 6 elements is used:

X=[q₀q₁q₂q₃θφ₀] Equation 8

where [q₀ q₁ q₂ q₃] are the scale and vector elements of a quaternion representing vector-rotation, θ is an inclination angle of the local magnetic field, and φ₀ is the initial yaw-angle offset in the angular position of the reference system.

The initial values of X and P₀ are

$$\begin{matrix}{X}_{0} = [ \begin{matrix}1 & 0 & 0 & 0 & 0 & 0\end{matrix} ] & Equation 9 \\ {P}_{0} = [ \begin{matrix}0 & 0 & 0 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] & Equation 10\end{matrix}$$

The process model for the state is static, i.e. X_{n+1|n}=X_{n|n}. The measurement model is

$${Z}_{n + 1} = {}_{}^{M}{\tilde{B}}{}_{n + 1}^{} = h ( X ) = A \times {}_{E}^{D}{R}{}_{n + 1}^{} \times [ \begin{matrix}cos {ϕ}_{0} •cos θ \\ sin {ϕ}_{0} •cos θ \\ sin θ\end{matrix} ] + {W}_{n + 1} \qquad Equation 11$$

The designed model of prediction is given by

$$h ( {X}_{n + 1 \vert n} ) = {A}_{n + 1 \vert n} \times {}_{E}^{D}{\hat{R}}{}_{n + 1}^{} \times {[ \begin{matrix}cos {ϕ}_{0} •cos θ \\ sin {ϕ}_{0} •cos θ \\ sin θ\end{matrix} ]}_{n + 1 \vert n} \qquad Equation 12$$

The relationship between the quaternion in the state X and the alignment matrix _{D}^{M}\hat{R} is given by,

$${}_{D}^{M}{\hat{R}}{}_{n}^{} = {A}_{n} = {[ \begin{matrix}\begin{matrix}{q}_{0} \cdot {q}_{0} + {q}_{1} \cdot {q}_{1} - \\ {q}_{2} \cdot {q}_{2} - {q}_{3} \cdot {q}_{3}\end{matrix} & 2 \cdot ( {q}_{1} \cdot {q}_{2} - {q}_{0} \cdot {q}_{3} ) & 2 \cdot ( {q}_{0} \cdot {q}_{2} + {q}_{1} \cdot {q}_{3} ) \\ 2 \cdot ( {q}_{1} \cdot {q}_{2} + {q}_{0} \cdot {q}_{3} ) & \begin{matrix}{q}_{0} \cdot {q}_{0} - {q}_{1} \cdot {q}_{1} + \\ {q}_{2} \cdot {q}_{2} - {q}_{3} \cdot {q}_{3 }\end{matrix} & 2 \cdot ( {q}_{2} \cdot {q}_{3} - {q}_{0} \cdot {q}_{1} ) \\ 2 \cdot ( {q}_{1} \cdot {q}_{3} - {q}_{0} \cdot {q}_{2} ) & 2 \cdot ( {q}_{0} \cdot {q}_{1} + {q}_{2} \cdot {q}_{3} ) & \begin{matrix}{q}_{0} \cdot {q}_{0} - {q}_{1} \cdot {q}_{1} - \\ {q}_{2} \cdot {q}_{2} + {q}_{3} \cdot {q}_{3}\end{matrix}\end{matrix} ]}_{n} \qquad Equation 13$$

Partial derivatives of A with respect to [q₀ q₁ q₂ q₃] are given by

$$\begin{matrix}\frac{\partial A}{\partial {q}_{0}} = 2 \cdot [ \begin{matrix}{q}_{0} & - {q}_{3} & {q}_{2} \\ {q}_{3} & {q}_{0} & - {q}_{1} \\ - {q}_{2} & {q}_{1} & {q}_{0}\end{matrix} ] & Equation 14 \\ \frac{\partial A}{\partial {q}_{1 }} = 2 \cdot [ \begin{matrix}{q}_{1} & {q}_{2} & {q}_{3} \\ {q}_{2} & - {q}_{1} & - {q}_{0} \\ {q}_{3} & {q}_{0} & - {q}_{1}\end{matrix} ] & Equation 15 \\ \frac{\partial A}{\partial {q}_{2}} = 2 \cdot [ \begin{matrix}- {q}_{2} & {q}_{1} & {q}_{0} \\ {q}_{1} & {q}_{2} & {q}_{3} \\ - {q}_{0} & {q}_{3} & - {q}_{2}\end{matrix} ] & Equation 16 \\ \frac{\partial A}{\partial {q}_{3 }} = 2 \cdot [ \begin{matrix}- {q}_{3} & - {q}_{0} & {q}_{1} \\ {q}_{0} & - {q}_{3} & {q}_{2} \\ {q}_{1} & {q}_{2} & {q}_{3}\end{matrix} ] & Equation 17\end{matrix}$$

Partial derivative of C with respect to θ and φ₀ are

$$\begin{matrix}\frac{\partial C}{\partial θ} = [ \begin{matrix}- sin θ \cdot cos {ϕ}_{0} \\ - sin θ \cdot sin {ϕ}_{0} \\ cos θ\end{matrix} ] & Equation 18 \\ \frac{\partial C}{\partial {ϕ}_{0}} = [ \begin{matrix}\begin{matrix}- cos θ \cdot sin {ϕ}_{0} \\ cos θ \cdot cos {ϕ}_{0}\end{matrix} \\ 0\end{matrix} ] & Equation 19\end{matrix}$$

G is defined as

$${G}_{n + 1} • {}_{E}^{D}{\hat{R}}{}_{n + 1}^{} \times {[ \begin{matrix}cos {ϕ}_{0} •cos θ \\ sin {ϕ}_{0} •cos θ \\ sin θ\end{matrix} ]}_{n + 1 \vert n} \qquad Equation 20$$

The Jacobian matrix whose elements are partial derivatives of h with respect to X is chosen as

$${\tilde{H}}_{n + 1} = [ \begin{matrix}0.5 \cdot \frac{\partial A}{\partial {q}_{0}} \times {G}_{n + 1} & 0.5 \cdot \frac{\partial A}{\partial {q}_{1}} \times {G}_{n + 1} & 0.5 \cdot \frac{\partial A}{\partial {q}_{2}} \times {G}_{n + 1} & 0.5 \cdot \frac{\partial A}{\partial {q}_{3}} \times {G}_{n + 1} & A \times {}_{E}^{D}{\hat{R}}{}_{n + 1}^{} \times \frac{\partial C}{\partial {θ}_{n + 1 \vert n}} & A \times {}_{E}^{D}{\hat{R}}{}_{n + 1 \vert n}^{} \times \frac{\partial C}{\partial {ϕ}_{0 n + 1 \vert n}}\end{matrix} ] \qquad Equation 21$$

The standard EKF computation procedure is used for the state and its error covariance matrix updates as follows:
(1) Error covariance prediction

P_{n+1|n}=P_{n|n}+Qₙ Equation 22
(2) Innovation computation

rₙ₊₁=Zₙ₊₁−\hat{Z}ₙ₊₁=^{M}\tilde{B}ₙ₊₁−h(X_{n+1|n}) Equation 23

Substituting Equation 12 into Equation 23, one obtains

$${r}_{n + 1} = {}_{}^{M}{\tilde{B}}{}_{n + 1}^{} - {A}_{n + 1 \vert n} \times {}_{E}^{D}{\hat{R}}{}_{n + 1}^{} \times {[ \begin{matrix}cos {ϕ}_{0} •cos θ \\ sin {ϕ}_{0} •cos θ \\ sin θ\end{matrix} ]}_{n + 1 \vert n} \qquad Equation 24$$

(3) Kalman gain computation

Sₙ₊₁=\tilde{H}ₙ₊₁×P_{n+1|n}×(\tilde{H}ₙ₊₁)^{T}+Rₙ₊₁ Equation 25

where R is the magnetometer measurement noise covariance given by

$$\begin{matrix}{R}_{n} = {[ \begin{matrix}{σ}_{x}^{2} & 0 & 0 \\ 0 & {σ}_{y}^{2} & 0 \\ 0 & 0 & {σ}_{z}^{2}\end{matrix} ]}_{n} & Equation 26 \\ {K}_{n + 1} = {P}_{n + 1 \vert n} \times {( {\tilde{H}}_{n + 1} )}^{T} \times {( {S}_{n + 1} )}^{- 1} & Equation 27\end{matrix}$$

(4) State correction

X_{n+1|n+1}=X_{n+1|n}+Kₙ₊₁×rₙ₊₁ Equation 28
(5) Error covariance correction

P_{n+1|n+1}=(I_{6×6}−Kₙ₊₁×\tilde{H}₊₁)×P_{n+1|n} Equation 29

Beyond the standard procedure of EKF, the method runs two more steps to keep the state bounded which stabilizes the recursive filter and prevents it from diverging by enforcing those two constraints.
(6) Quaternion normalization, a valid quaternion representing a rotation matrix has amplitude of 1

$${X}_{n + 1} ( 1 \text{:} 4 ) = \frac{{X}_{n + 1 \vert n + 1} ( 1 \text{:} 4 )}{\vert {X}_{n + 1 \vert n + 1} ( 1 \text{:} 4 ) \vert}$$

(7) Phase wrap on inclination angle and initial yaw angle offset, a valid inclination angle is bounded between

$$- \frac{π}{2} and \frac{π}{2} ,$$

and a valid yaw angle is bounded between −π and π. First, the inclination angle estimate is limited to be within (−π, π], for example, by using

Xₙ₊₁(5)=phaseLimiter(X_{n+1|n+1}(5)) Equation 30
where y=phaseLimiter(x) function does the following:

Code 1

```
y = x;
while (1)
  if y <= −pi
    y = y + 2*pi;
  elseif y > pi
    y = y − 2*pi;
  else
    break;
  end
end
```

Secondly, the inclination angle estimate is further limited to be within

$$( - \frac{π}{2} , \frac{π}{2} ] ,$$

since this operation changes the sign of cosine and sine, the appropriate change on initial yaw angle offset estimate needs to be accompanied, the exemplary code is as follows:

Code 2

```
if X(5) > pi/2
  X(5) = pi − X(5);
  X(6) = X(6) + pi;
elseif X(5) < −pi/2
    X(5) = −pi − X(5);
    X(6) = X(6) + pi;
end
```

Last, the initial yaw angle offset estimate is limited to be within (−π, π]

Xₙ₊₁(6)=phaseLimiter(X_{n+1|n+1}(6)) Equation 31

Steps 6 and 7 are necessary and critical although they are not sufficient to keep the filter stable, and do not make the filter to converge faster.

Another control factor added in this method is the dynamic Q adjustment. In conventional methods, Q=0 since the state of estimate is constant over time. However this leads to a very slow convergence rate when the data sequence is not very friendly. For example, if initially all the data points collected are from a very small neighborhood of an angular position for a long time, which could eventually drive P to be very small since each time step renders P a little bit smaller. When more data points are then collected from wide variety of angular positions but in a very short time system, the filter is not able to quickly update its state to the truth due to very small P.

This method allows nonzero Q which enables the filter to update the system state at a reasonable pace. In general, the risk to increase P such that P becomes very large and makes the filter unstable exists, but the method allows to adjust Q dynamically and thus to ensure it has the advantage of fast convergence and also is stable enough. For this purpose, a constant baseline Q₀ is set to be the maximum change the filter can make with respect to the full dynamic range and the variable can take for each time step.

$${Q}_{0} = [ \begin{matrix}{Const}^{2} & 0 & 0 & 0 & 0 & 0 \\ 0 & {Const}^{2} & 0 & 0 & 0 & 0 \\ 0 & 0 & {Const}^{2} & 0 & 0 & 0 \\ 0 & 0 & 0 & {Const}^{2} & 0 & 0 \\ 0 & 0 & 0 & 0 & \frac{{π}^{2}}{4} \cdot {Const}^{2} & 0 \\ 0 & 0 & 0 & 0 & 0 & {π}^{2} \cdot {Const}^{2}\end{matrix} ] \qquad Equation 32$$

Two dynamic-change multiplication factors are used in this method for adjusting the final Q at each time step:

Qₙ=k₁·k₂·Q₀ Equation 33

Multiplication factor k₁ is designed to be a function of the difference of the estimated misalignment angles between the current system state and the system state obtained from accuracy verification algorithm. When the difference is big enough, k₁=1 enables the filter runs its maximum converge speed. When the difference is small enough comparing to the desired accuracy, k₁<<1 ensures the filter slowing down and performs micro-adjusting. In an exemplary embodiment, this relationship is implemented at each time step as follows:

Code 3

```
if diffAngle >= constant threshold (degree)
  k1 = 1;
elseif diffAngle >= 1
  k1 = a * diffAngle;
else
  k1 = α;
end
```

where α is a non-negative constant and much less than 1.

Multiplication factor k₂ is a decay factor. When the angular positions are in the neighborhood of a fixed angular position, k₂ decays exponentially. When angular position changes more than a pre-defined threshold ANGLE_TOL, k₂ jumps back to 1. By doing this, it avoids the filter from having P much bigger when the device stays within very narrow angular position space. The stability is thus ensured. The difference between two angular positions is given by
dcmDiff=A*Aold′;
[v, phi]=qdecomp(dcm2q(dcmDiff));
   Code 4
      where A and Aold are direction-cosine matrix representations of two quaternions respectively, q=dcm2q(dcm) is a function converting the direction-cosine matrix into quaternion representation, and [v, phi]=qdecomp(q) is a function to breaks out the unit vector and angle of rotation components of the quaternion.

An exemplary implementation of k₂ computation is given by

Code 5

```
if phi >= ANGLE_TOL
  Aold = A;
  k2 = 1;
else
  k2 = DECAY_FACTOR * k2;
end
```

The DECAY_FACTOR may be, for example, set to be 0.95.

When the state is updated with latest measurement, the estimated inclination angle and yaw angle offset are used to construct the best sequence of

$${\tilde{G}}_{i} • {}_{E}^{D}{\hat{R}}{}_{i}^{} \times {[ \begin{matrix}cos {ϕ}_{0} •cos θ \\ sin {ϕ}_{0} •cos θ \\ sin θ\end{matrix} ]}_{n + 1} , i = 1 , … , n + 1 \qquad Equation 34$$

Given sequence pairs of ^{M}\tilde{B}ᵢ and \tilde{G}ᵢ, i=1, . . . , n+1, solving Aₙ becomes what is known as the Wahba problem. Many alternative algorithms have been developed to solve this problem. The Landis Markley's SVD (Singular Value Decomposition) algorithm used here is described as step 1-4 below:
(1) Compose the 3×3 matrix L

$${L}_{n + 1} = {\sum }_{i = 1}^{n + 1} {}_{}^{M}{\tilde{B}}{}_{i}^{} \times {( {\tilde{G}}_{i} )}^{T} \qquad Equation 35$$

(2) Decompose L using singular value decomposition (SVD)

[usv]=SVD(L) Equation 36
(3) Compute the sign and construct w

$$w = [ \begin{matrix}1 & 0 & 0 \\ 0 & 1 & 0 \\ 0 & 0 & det ( u \times {v}^{T} )\end{matrix} ] \qquad Equation 37$$

(4) Compute A

A=u×w×v^{T} Equation 38

When A is computed, the method compares this A with the one obtained in the latest state of above EKF, and the angle of difference is computed using Code 4. The angle of difference is the estimate of accuracy of the estimated alignment matrix. As previously mentioned, the angle of difference is also feedback to determine the multiplication factor of k₁ in dynamic Q adjustment in designed EKF.

For easier real-time implementation, 9 1×3 vector variables are used to store historical data recursively as follows:

$$\{ \begin{matrix}ele {1}_{n + 1} = ele {1}_{n} + {}_{}^{M}{B}{}_{n + 1}^{} ( 1 ) \cdot {}_{E}^{D}{\hat{R}}{}_{n + 1}^{} ( 1 , \text{:} ) \\ ele {2}_{n + 1} = ele {2}_{n} + {}_{}^{M}{B}{}_{n + 1}^{} ( 1 ) \cdot {}_{E}^{D}{\hat{R}}{}_{n + 1}^{} ( 2 , \text{:} ) \\ ele {3}_{n + 1} = ele {3}_{n} + {}_{}^{M}{B}{}_{n + 1}^{} ( 1 ) \cdot {}_{E}^{D}{\hat{R}}{}_{n + 1}^{} ( 3 , \text{:} ) \\ ele {4}_{n + 1} = ele {4}_{n} + {}_{}^{M}{B}{}_{n + 1}^{} ( 2 ) \cdot {}_{E}^{D}{\hat{R}}{}_{n + 1}^{} ( 1 , \text{:} ) \\ ele {5}_{n + 1} = ele {5}_{n} + {}_{}^{M}{B}{}_{n + 1}^{} ( 2 ) \cdot {}_{E}^{D}{\hat{R}}{}_{n + 1}^{} ( 2 , \text{:} ) \\ ele {6}_{n + 1} = ele {6}_{n} + {}_{}^{M}{B}{}_{n + 1}^{} ( 2 ) \cdot {}_{E}^{D}{\hat{R}}{}_{n + 1}^{} ( 3 , \text{:} ) \\ ele {7}_{n + 1} = ele {7}_{n} + {}_{}^{M}{B}{}_{n + 1}^{} ( 3 ) \cdot {}_{E}^{D}{\hat{R}}{}_{n + 1}^{} ( 1 , \text{:} ) \\ ele {8}_{n + 1} = ele {8}_{n} + {}_{}^{M}{B}{}_{n + 1}^{} ( 3 ) \cdot {}_{E}^{D}{\hat{R}}{}_{n + 1}^{} ( 2 , \text{:} ) \\ ele {9}_{n + 1} = ele {9}_{n} + {}_{}^{M}{B}{}_{n + 1}^{} ( 3 ) \cdot {}_{E}^{D}{\hat{R}}{}_{n + 1}^{} ( 3 , \text{:} )\end{matrix} \qquad Equation 39$$

Therefore, the Equation 35 can be computed using

$${L}_{n + 1} = [ \begin{matrix}ele {1}_{n + 1} \times {C}_{n + 1} & ele {4}_{n + 1} \times {C}_{n + 1} & ele {7}_{n + 1} \times {C}_{n + 1} \\ ele {2}_{n + 1} \times {C}_{n + 1} & ele {5}_{n + 1} \times {C}_{n + 1} & ele {8}_{n + 1} \times {C}_{n + 1} \\ ele {3}_{n + 1} \times {C}_{n + 1} & ele {6}_{n + 1} \times {C}_{n + 1} & ele {9}_{n + 1} \times {C}_{n + 1}\end{matrix} ] \qquad Equation 40$$

The referenced sequences of angular positions may come from any combination of other motion sensors, even from another magnetometer. The method may be used for other sensor units that have a nine-axis type of sensor unit with a 3-D accelerometer and a 3-D rotational sensor. The referenced sequences of angular position may be obtained using various sensor-fusion algorithms.

The Earth-fixed gravitational reference system may be defined to have other directions as the x-axis and the z-axis, instead of the gravity and the magnetic North as long as the axes of the gravitational reference system may be located using the gravity and the magnetic North directions.

If the referenced angular position does not have an unknown yaw offset, then the φ₀ can be the yaw angle of local magnetic field with respect to the referenced earth-fixed coordinate system, and Equation 4 is rewritten as

$${}^{E} H = \vert {}^{E} H \vert \cdot [ \begin{matrix}cos {ϕ}_{0} & - sin {ϕ}_{0} & 0 \\ sin {ϕ}_{0} & cos {ϕ}_{0} & 0 \\ 0 & 0 & 1\end{matrix} ] \times [ \begin{matrix}cos θ \\ 0 \\ sin θ\end{matrix} ] \qquad Equation 41$$

After such alignment matrix is obtained, the local magnetic field vector is also solved in earth-fixed coordinate system automatically since φ₀ and θ are solved simultaneously in the EKF state.

The algorithm of alignment can be used for any sensor 3D alignment with any referenced device body and is not limited to magnetometer or inertial measurement sensors.

The algorithm of alignment can take the batch of data at once to solve it in one step.

The method may employ other algorithms to solve the Wahba problem instead of the one described above for the accuracy verification algorithm.

Additionally, a stability counter can be used for ensuring that the angle difference is less than a predetermined tolerance for a number of iterations to avoid coincidence (i.e., looping while the solution cannot be improved).

Other initialization of the EKF may be used to achieve a similar result. The alignment estimation algorithm is not sensitive to the initialization.

The constants used in the above exemplary embodiments can be tuned to achieve specific purposes. The values of the multiplication factors k₁ and k₂ and their adaptively change behavior can be different from the exemplary embodiment depending on the environment, sensors and application, etc.

To summarize, methods described in this section provide a simple, fast, and stable way to estimate the misalignment of magnetometer in real-time with respect to the device body-fixed reference system in any unknown environment, an unknown inclination angle and an unknown yaw angle offset in the referenced attitudes (totally 5 independent variables) as long as all the other parameters (scale, skew, and offset) have already been pre-calibrated or are otherwise known with sufficient accuracy. These methods do not require prior knowledge of the local magnetic field in the Earth-fixed gravitational reference system. Verification methods for alignment accuracy are associated with the alignment algorithm to enable a real-time reliable, robust, and friendly operation.

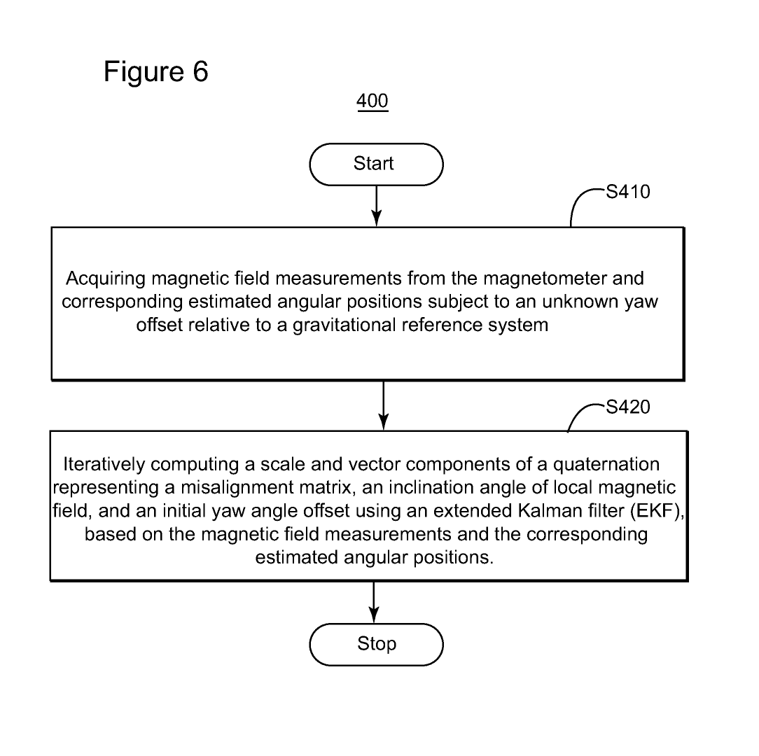

A flow diagram of a method 400 method for calibrating attitude dependent magnetometer alignment parameters of a magnetometer mounted together with other angular position sensors on a device is illustrated in FIG. 6. The method 400 includes acquiring magnetic field measurements from the magnetometer and associated estimated angular positions' sequence subject to an unknown yaw offset relative to a gravitational reference system, at S410. The method 400 further includes iteratively computing a scale and vector components of a quaternion representing a misalignment matrix, an inclination angle of local magnetic field, and a yaw angle offset using an extended Kalman filter (EKF) infrastructure with specific designed model and constraints based on the magnetic field measurements and the estimated angular position, at S420.

The disclosed exemplary embodiments provide methods that may be part of a toolkit useable when a magnetometer is used in combination with other sensors to determine orientation of a device, and systems capable to use the toolkit. The methods may be embodied in a computer program product. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Exemplary embodiments may take the form of an entirely hardware embodiment or an embodiment combining hardware and software aspects. Further, the exemplary embodiments may take the form of a computer program product stored on a computer-readable storage medium having computer-readable instructions embodied in the medium. Any suitable computer readable medium may be utilized including hard disks, CD-ROMs, digital versatile disc (DVD), optical storage devices, or magnetic storage devices such a floppy disk or magnetic tape. Other non-limiting examples of computer readable media include flash-type memories or other known memories.

Although the features and elements of the present exemplary embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a specifically programmed computer or processor.

1. A method for calibrating attitude dependent magnetometer alignment parameters of a magnetometer mounted together with other angular position sensors on a device, the method comprising:
acquiring magnetic field measurements from the magnetometer and corresponding estimated angular positions subject to an unknown yaw offset relative to a gravitational reference system; and
iteratively computing a scale and vector components of a quaternion representing a misalignment matrix, an inclination angle of local magnetic field, and a yaw angle offset using an extended Kalman filter (EKF) infrastructure with a specific designed model and constraints, based on the magnetic field measurements and the corresponding estimated angular positions.

2. The method of claim 1, wherein computing the EKF comprises, in each iteration,
predicting an error covariance as a sum of error covariance matrix at a previous step and an error covariance matrix of a process model of the EKF;
calculating a difference between a normalized measurement and an observation model of the EKF;
calculating a Kalman gain using (1) a Jacobian matrix of partial derivatives of the observation model with respect to a current state of the EKF, (2) the predicted error covariance and (3) a magnetometer noise covariance;
performing state correction using the calculated Kalman gain and the predicted error covariance;
performing an error covariance correction using the Kalman gain and the Jacobian matrix of partial derivatives of the observation model with respect to a current state of the EKF;
normalizing the quaternion; and
limiting the inclination angle to be between
$$- \frac{π}{2} and \frac{π}{2} ,$$
and the initial yaw angle offset to be between −π and π.

3. The method of claim 2, wherein the error covariance matrix of the process model of EKF is updated dynamically by multiplying a baseline constant matrix with
a first factor depending on an angle difference between estimated misalignment angles between of a current system state and of a system state obtained from an accuracy verification algorithm, and
a second factor that depends on a magnitude of a change in the estimated angular position.

4. The method of claim 3, wherein the first factor is
1 if the angle difference is larger than a predetermined threshold,
α×the angle difference if the angle difference is larger than 1, and
α otherwise, wherein α is a non-negative constant much smaller than 1.

5. The method of claim 3, wherein the second factor is a factor decaying being multiplied with a fixed quantity less than 1 if a difference between angular positions determined at successive steps is less than a predetermined threshold, and it is set to 1 if the difference between the angular positions determined at successive steps is larger than the predetermined threshold.

6. The method of claim 1, wherein the computing of the EKF is reduced to a Wahba problem.

7. The method of claim 6, wherein the Wahba problem is solved using singular value decomposition.

8. The method of claim 7, further comprising solving the Wahba problem using a method different from SVD for accuracy measurement.

9. The method of claim 1, wherein the iteratively computing of the scale and the vector components of the quaternion stops when a difference between angles determined in successive iterations becomes less than a predetermined threshold or when after a predetermined number of iterations.

10. An apparatus configured to perform a calibration of attitude-dependent magnetometer alignment parameters of a magnetometer mounted together with other angular position sensors on a device, comprising:
an interface configured to receive magnetic field measurements and corresponding estimated angular positions subject to an unknown yaw offset of the device relative to a gravitational reference system; and
a data processing unit configured to iteratively compute a scale and vector components of a quaternion representing a misalignment matrix, an inclination angle of local magnetic field, and a yaw angle offset using an extended Kalman filter infrastructure with a specific designed model and constraints, based on the magnetic field measurements and the corresponding estimated angular positions.

11. The apparatus of claim 10, wherein the data processing unit is configured to perform, for each iteration,
predicting an error covariance as a sum of error covariance matrix at a previous step and an error covariance matrix of a process model of the EKF;
calculating a difference between a normalized measurement and an observation model of the EKF;
calculating a Kalman gain using (1) a Jacobian matrix of partial derivatives of the observation model with respect to a current state of the EKF, (2) the predicted error covariance and (3) a magnetometer noise covariance;
performing state correction using the calculated Kalman gain and the predicted error covariance;
performing an error covariance correction using the Kalman gain and the Jacobian matrix of partial derivatives of the observation model with respect to a current state of the EKF;
normalizing the quaternion; and
limiting the inclination angle to be between
$$- \frac{π}{2} and \frac{π}{2} ,$$
and the initial yaw angle offset to be between −π and π.

12. The apparatus of claim 10, wherein the data processing unit is configured to update dynamically the error covariance matrix of the process model of EKF by multiplying a baseline constant matrix with
a first factor depending on an angle difference between estimated misalignment angles between of a current system state and of a system state obtained from an accuracy verification algorithm, and
a second factor that depends on a magnitude of a change in the estimated angular position.

13. The apparatus of claim 12, wherein the first factor is
1 if the angle difference is larger than a predetermined threshold,
α×the angle difference if the angle difference is larger than 1, and
is α otherwise, wherein α is a non-negative constant much smaller than 1.

14. The apparatus of claim 12, wherein the second factor is a factor decaying being multiplied with a fixed quantity less than 1 if a difference between angular positions determined at successive steps less than a predetermined threshold, and it is set to 1 if the difference between the angular positions determined at successive steps is larger than the predetermined threshold.

15. The apparatus of claim 10, wherein the data processing unit is configured to reduce the computing of the EKF to a Wahba problem.

16. The apparatus of claim 15, wherein the data processing unit is configured to solve the Wahba problem using singular value decomposition.

17. The apparatus of claim 16, wherein the data processing unit is configured to perform an accuracy measurement by solving the Wahba problem using a method different from SVD.

18. The apparatus of claim 16, wherein the data processing unit is configured to stop iteratively computing the scale and the vector components of the quaternion when a difference between angles determined in successive iterations becomes less than a predetermined threshold or when after a predetermined number of iterations.

19. A computer readable medium storing executable codes which when executed by a processor make the processor execute a method calibrating attitude dependent magnetometer alignment parameters of a magnetometer mounted together with other angular position sensors on a device, the method comprising:
acquiring magnetic field measurements from the magnetometer and corresponding estimated angular positions subject to an unknown yaw offset relative to a gravitational reference system; and
iteratively computing a scale and vector components of a quaternion representing a misalignment matrix, an inclination angle of local magnetic field, and a yaw angle offset using an extended Kalman filter infrastructure with a specific designed model and constraints, based on the magnetic field measurements and the estimated angular position.

20. The computer readable medium of claim 19, wherein computing the EKF comprises, in each iteration:
predicting an error covariance as a sum of error covariance matrix at a previous step and an error covariance matrix of a process model of the EKF;
calculating a difference between a normalized measurement and an observation model of the EKF;
calculating a Kalman gain using (1) a Jacobian matrix of partial derivatives of the observation model with respect to a current state of the EKF, (2) the predicted error covariance and (3) a magnetometer noise covariance;
performing state correction using the calculated Kalman gain and the predicted error covariance;
performing an error covariance correction using the Kalman gain and the Jacobian matrix of partial derivatives of the observation model with respect to a current state of the EKF;
normalizing the quaternion; and
limiting the inclination angle to be between
$$- \frac{π}{2} and \frac{π}{2} ,$$
and the initial yaw angle offset to be between −π and π.

21. The computer readable medium of claim 20, wherein the error covariance matrix of the process model of EKF is updated dynamically by multiplying a baseline constant matrix with
a first factor depending on an angle difference between estimated misalignment angles between of a current system state and of a system state obtained from an accuracy verification algorithm, and
a second factor that depends on a magnitude of a change in the estimated angular position.

22. The computer readable medium of claim 21, wherein the first factor is
1 if the angle difference is larger than a predetermined threshold,
α*the angle difference if the angle difference is larger than 1, and
is α otherwise, wherein α is a non-negative constant much smaller than 1.

23. The computer readable medium of claim 21, wherein the second factor is a factor decaying being multiplied with a fixed quantity less than 1 if a difference between angular positions determined at successive steps less than a predetermined threshold, and it is set to 1 if the difference between the angular positions determined at successive steps is larger than the predetermined threshold.

24. The computer readable medium of claim 19, wherein the computing of the EKF is reduced to a Wahba problem.

25. The computer readable medium of claim 24, wherein the Wahba problem is solved using singular value decomposition.

26. The computer readable medium of claim 25, further comprising solving the Wahba problem using a method different from SVD for accuracy measurement.

27. The computer readable medium of claim 19, wherein the iteratively computing of the scale and the vector components of the quaternion stops when a difference between angles determined in successive iterations becomes less than a predetermined threshold or when after a predetermined number of iterations.
